(19) United States
(12) Patent Application Publication
(10) Pub. No.: US 2016/0369108 A1
(43) Pub. Date: Dec. 22, 2016

(54) ANTICORROSION WAX COMPOSITION CONTAINING PLATE ZINC FLAKE

(71) Applicant: Hyundai Motor Company, Seoul (KR)

(72) Inventor: Eun Young CHUNG, Gunpo-si (KR)

(21) Appl. No.: 14/872,916

(22) Filed: Oct. 1, 2015

(30) Foreign Application Priority Data
Jun. 19, 2015 (KR) 10-2015-0087686

(51) Int. Cl. C09D 5/10

(52) U.S. Cl. CPC C09D 5/106

(57) ABSTRACT

An anticorrosion wax composition containing plate zinc flake includes plate zinc flake 5 to 15 wt %, anticorrosion additives 38 to 50 wt %, wax 15 to 20 wt %, oil 10 to 15 wt %, alkyd resin 5 to 10 wt %, and additives 0.5 to 2 wt %.

### CROSS-REFERENCE TO RELATED APPLICATION

This application claims, under 35 U.S.C. §119(a), the benefit of Korean Patent Application No. 10-2015-0087686, filed Jun. 19, 2015 with the Korean Intellectual Property Office, the entire contents of which are incorporated herein by reference.

### TECHNICAL FIELD

The present disclosure relates to an anticorrosion wax composition containing plate zinc flake. More particularly, the present disclosure relates to an anticorrosion wax composition containing plate zinc flake, which has improved corrosion resistance and anticorrosion performance by adding the plate zinc flake to the anticorrosion wax composition and also has improved visibility. Thereby whether the wax is coated or not to the inside of closed section or recessed parts of components can be easily confirmed.

### BACKGROUND

Commonly used wax is largely classified into oil-soluble types and water-soluble types. Petroleum-based wax is often a main ingredient, and contains anticorrosion additives, oil, resins and the like. In particular, cavity wax, which is coated on a gap of the bottom end of a car door, outer panel of a chassis frame, and inner panel of a closed section to improve anticorrosion performance, is coated by nozzle spraying at the region where anticorrosion performance is needed in a thickness of about 50 to 300 μm. This cavity wax protects the coated film and car body steel plate from salt, calcium chloride, moisture and acid/alkali chemicals, thereby improving anticorrosion performance for as long as five to seven years, relative to the uncoated region.

However, existing cavity wax is sprayed to a frame or a closed section of a car body using a nozzle, but it is difficult to determine whether a section is coated or not after spraying, the amount of the wax sprayed, and whether a recessed region is coated. Thus, it is difficult to distinguish whether the cavity wax has coated the section or not, even when it is observed with an endoscope, because the inside of the closed section is dark and the cavity wax color is transparent as black or pale yellow. Thus, visibility for determining coating completeness is not optimal.

Korean Patent Publication No.820408 discloses an anticorrosion wax composition containing naphthene-based mineral oil, wax, anticorrosion additives, alkyd resin and additives, but it does not recognize visibility enhancements.

Further, Japanese Patent Laid-Open Publication No.2010-144205 discloses an anticorrosion agent comprising dye or organic pigment, which has the maximum absorption wavelength in a visible light region of a range of 500 to 700 nm, or Carbon Black whose surface is hydrophobically treated, and a coloring agent for enhancing visibility. However, this has problems of a lack of visibility continuity and poor physical properties such as corrosion resistance.

Thus, a wax is needed which has improved anticorrosion performance and also has improved visibility, which can allow an easy confirmation of whether the wax is coated or not to recessed parts of a car body.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to solve the above-described problems associated with prior art.

The present disclosure is formed by finding that when plate zinc flake is added to anticorrosion wax composition, corrosion resistance and anticorrosion performance can be improved, and also visibility can be enhanced at the same time.

Accordingly, the present disclosure is objected to provide an anticorrosion wax composition containing plate zinc flake having improved visibility.

Further, the present disclosure is objected to provide an anticorrosion wax composition containing plate zinc flake having improved corrosion resistance and anticorrosion performance.

In one aspect, the present disclosure provides an anticorrosion wax composition containing plate zinc flake comprising: plate zinc flake 5 to 15 wt %; anticorrosion additives 38 to 50 wt %; wax 15 to 20 wt %; oil 10 to 15 wt %; alkyd resin 5 to 10 wt %; and additives 0.5 to 2 wt %.

In a preferred embodiment, the plate zinc flake may be in a leaf-shape.

In another preferred embodiment, the plate zinc flake may be 0.1 to 2 μm in thickness, 5 to 40 μm in width, and 10 to 20 μm in length.

In still another preferred embodiment, the anticorrosion additives may comprise at least one selected from the group consisting of calcium petroleum sulfonate wax, sodium petroleum sulfonate wax and modified metal alkyl aryl.

In yet another preferred embodiment, the wax may be oxidized petroleum wax, microcrystalline wax or a mixture thereof.

In still yet another preferred embodiment, the oil may be at least one selected from the group consisting of mineral spirits, polybutene, butyl cellosolve and naphthene.

In a further preferred embodiment, the additives may comprise a defoamer, surfactant or a mixture thereof.

Other aspects and preferred embodiments of the disclosure are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### DETAILED DESCRIPTION

Hereinafter reference will now be made in detail to various embodiments of the present disclosure, examples of which are illustrated in the accompanying drawings and described below. While the disclosure will be described in conjunction with exemplary embodiments, it will be understood that present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

The anticorrosion wax composition of the present disclosure may comprise: plate zinc flake 5 to 15 wt %; anticorrosion additives 38 to 50 wt %; wax 15 to 20 wt %; oil 10 to 15 wt %; alkyd resin 5 to 10 wt %; and additives 0.5 to 2 wt %.

The anticorrosion wax composition may have an effect of easily confirming whether the wax is coated or not to the inside of a closed section or a recessed part of components because it has improved visibility due to adding the plate zinc flake, as compared to a spherical, agglomerated-shape or indeterminate-shape. This anticorrosion wax composition having improved visibility can be manufactured by mixing the plate zinc flake to general solvent-type and solvent free-type anticorrosion wax.

The plate zinc flake has a flat plate structure, which is obtained by processing zinc powder by an atomize method or heating at a melting point or higher temperature and vaporizing to obtain spherical zinc (Zn) particles, and then processing the particles by a milling method, and having a similar shape and gloss to dolla-type of aluminum flake.

This plate zinc flake may be in a leaf-shape. Herein, the leaf-shape comprehensively means leaf-shape, circle-shape, oval-shape, diamond-shape and the like. The leaf-shaped plate zinc flake may be 0.1 to 2 μm in thickness, 5 to 40 μm in width, and 10 to 20 μm in length. Specifically, if a length of the plate zinc flake is shorter than 10 μm, sparkling visibility of the zinc may deteriorate, and if the length is longer than 20 μm, there may be a problem of blocking of a spray coating nozzle. Further, if the content of the plate zinc flake is less than 5 wt %, visibility may deteriorate, and if the content is over 15 wt %, anticorrosion performance may deteriorate.

The anticorrosion additives may be at least one selected from the group consisting of calcium petroleum sulfonate wax, sodium petroleum sulfonate wax and modified metal alkyl aryl. Specifically, the anticorrosion additives may have a metal salt sulfonate structure, and anticorrosion performance thereof may vary according to the type of alkyl group. The metal salt sulfonate may prevent corrosion of a metal surface because of the metal sulfaonate having emulsibility with a surface activating group. Namely, the double bond of an oxygen atom in the metal salt sulfonate conducts chemical adsorption with metal, and accordingly the double bond can block attachment of moisture and oxygen, which are causes of rust, to the metal surface. According to the present disclosure, surface activity can be a result of sulfonate group contained in the calcium petroleum sulfonate or the sodium petroleum sulfonate, and the emulsibility may be obtained by neutralization of calcium or sodium. Further, if the content of the anticorrosion additives is less than 38 wt %, anticorrosion performance may deteriorate, and if the content is over 50 wt %, there may be a problem of deterioration of flowability.

The wax may be oxidized petroleum wax, microcrystalline wax or a mixture thereof. Specifically, the oxidized petroleum wax has a melting point of 80° C. and total acid number of 17.5 mg KOH/g, and is characterized in that it is easily mixed with oil. If the content of this wax is less than 15 wt %, the petroleum wax cannot function as anticorrosion wax due to poor anticorrosion performance, and if the content is over 20 wt %, anticorrosion performance may be good, but there may be a problem of longer drying time.

The oil may be at least one selected from the group consisting of mineral spirits, polybutene, butyl cellosolve and naphthene. Specifically, if the content of the oil is less than 10 wt %, the wax may not be sprayed due to high viscosity, if the content is over 15 wt %, drying time may become longer and it may run down after spraying.

The alkyd resin is used for controlling drying workability of the wax, and it may have kinematic viscosity of 31 cSt at 40° C., and total acid number of 22 mg KOH/g. Further, if the content of the alkyd resin is less than 5 wt %, the anticorrosion wax may run down, and if the content is over 10 wt %, drying time may become longer and stability may deteriorate.

The additives may be defoamer, surfactant or a mixture thereof. Specifically, the defoamer may be acryl polymer, and it can suppress generation of bubbles in the anticorrosion wax. The surfactant may be fatty acid ester, and plays a role of effectively absorbing moisture stained on the surface of a car body when coating. If the content of the additives is less than 0.5 wt %, the wax may run down because the wax is not easily dried, and if the content is over 2 wt %, the wax may not be sprayed because the wax has been already dried.

Accordingly, the anticorrosion wax according to the present disclosure has an effect of easily confirming whether the wax is coated or not to the inside of closed section or recessed parts of components because it has improved corrosion resistance and anticorrosion performance by adding the plate zinc flake to the anticorrosion wax composition and also has improved visibility by adding said zinc flake in a small amount.

### EXAMPLES

The following examples illustrate the disclosure and are not intended to limit the same.

### Example and Comparative Examples 1 to 3

Cavity anticorrosion wax was prepared by mixing the ingredients listed in the following Table 1 with a certain content ratio.

TABLE 1

| Raw Materials | | | Comparative | Comparative | Comparative |
|---|---|---|---|---|---|
| (wt %) | | Example | Example 1 | Example 2 | Example 3 |
| Pigment | Plate Zinc | 9 | 4 | 16 | — |
| | Flake | | | | |
| | Spherical Zinc | — | — | — | 9 |
| | Flake | | | | |
| Anticorrosion | Sodium | 15 | 17 | 10 | 15 |
| Additives | Petroleum | | | | |
| | Sulfate | | | | |
| | Modified Metal | 30 | 33 | 28 | 30 |
| | Alkyl Aryl | | | | |
| Wax | Oxidized | 15 | 15 | 15 | 15 |
| | Petroleum Wax | | | | |
| | Microcrystalline | 5 | 5 | 5 | 5 |
| | Wax | | | | |
| Oil | Naphthene oil | 15 | 15 | 15 | 15 |
| Resin | Alkyd resin | 10 | 10 | 10 | 10 |
| Additives | Defoamer | 0.5 | 0.5 | 0.5 | 0.5 |
| | Surfactant | 0.5 | 0.5 | 0.5 | 0.5 |
| Total | wt % | 100 | 100 | 100 | 100 |
| Visibility | 10° | 4.07 | 1.03 | 2.16 | 0.50 |
| (Sparkle | 45° | 4.42 | 1.59 | 2.49 | 0.92 |
| Grade) | 75° | 4.05 | 2.10 | 2.07 | 0.98 |

| | | | | |
|---|---|---|---|---|
| Judgement with Naked Eyes | Proper | Improper(partly | Improper | Improper |
| | | rusted) | (partly rusted) | (partly rusted) |
| Corrosion Resistance(Hr) | 1500 | 800 | 600 | 860 |
| Specific Gravity | 1.01 | 0.99 | 1.02 | 1.03 |

Plate Zinc Flake: 1 μm in Thickness, 20 μm in Width, and 15 μm in Length
Defoamer: Acryl Polymer
Surfactant: Fatty Acid Ester

### Test Example: Evaluation of Visibility and Corrosion Resistance

In order to confirm visibility and corrosion resistance of the anticorrosion wax manufactured in Example and Comparative Examples 1 to 3, those were evaluated as described below, and the results are shown in the above Table 1.

[Measurement Method]

(1) Evaluation of Visibility

In order to evaluate visibility of the wax manufactured in Example and Comparative Examples 1 to 3, visibility was measured at 15°, 45° and 75° using a measuring device of BYKMAC (BYK-Chemie GmbH). As a measuring item, Sparkle grade showing the grade of sparkle was used. As evaluation standard, Sparkle Grade was divided from 0.1 to 5.0, and as the grade is higher, visibility is better, and as the grade is lower, visibility is worse. Because DI measuring device measures sparkle, which is reflected when a sensor is contacted to a coated film and irradiates light, sparkle was measured after putting glass between the sensor and the wax in order to avoid direct contact with the wax. Further, the wax manufactured in Example and Comparative Examples 1 to 3 was coated on a steel plate painted with black pigment, glass was put thereon, and then measured.

(2) Evaluation of Corrosion Resistance

The wax was coated on a cold rolled steel plate in a thickness of 100 μm, and then evaluated by SST (JIS Z 2371) to measure red rust generating time.

According to the result of the above Table 1, it was confirmed that Comparative Examples 1 and 3 were improper because sparkle was not detected even with naked eyes, visibility, and corrosion resistance significantly deteriorated. Further, in Comparative Example 3 where the spherical zinc flake was mixed, visibility was not good. Thus, it was found that the spherical zinc flake was agglomerated, and accordingly visibility was reduced.

Further, in the case of Comparative Example 2, it was found that visibility was partly improved as compared to Comparative Example 1, but the value was not high, and corrosion resistance was largely reduced.

On the contrary, in the case of Example, all of the sparkle grades in the visibility evaluation were 4.0 or more, and the value in the corrosion resistance evaluation was 1500 Hr. Accordingly, it was confirmed that anticorrosion performance was excellent.

Thus, it was found that the anticorrosion wax manufactured in Example has an effect of easily being able to confirm whether the wax is coated or not to the inside of closed section or recessed part of components because the wax has improved corrosion resistance and anticorrosion performance by adding the plate zinc flake to the anticorrosion wax composition and also has improved visibility by adding plate zinc flake.

The anticorrosion wax according to the present disclosure has an effect of easily allowing confirmation of whether the wax is coated or not to the inside of closed section or recessed part of components because the wax has improved corrosion resistance and anticorrosion performance by adding the plate zinc flake to the anticorrosion wax composition and also has improved visibility by adding pate zinc flake.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. An anticorrosion wax composition containing plate zinc flake comprising:
plate zinc flake of 5 to 15 wt %;
anticorrosion additives of 38 to 50 wt %;
wax of 15 to 20 wt %;
oil of 10 to 15 wt %;
alkyd resin of 5 to 10 wt %; and
additives of 0.5 to 2 wt %.

2. The anticorrosion wax composition containing plate zinc flake of claim 1, wherein the plate zinc flake is in a leaf-shape.

3. The anticorrosion wax composition containing plate zinc flake of claim 1, wherein the plate zinc flake is 0.1 to 2 μm in thickness, 5 to 40 μm in width, and 10 to 20 μm in length.

4. The anticorrosion wax composition containing plate zinc flake of claim 1, wherein the anticorrosion additives comprise at least one selected from the group consisting of calcium petroleum sulfonate, sodium petroleum sulfonate and modified metal alkyl aryl.

5. The anticorrosion wax composition containing plate zinc flake of claim 1, wherein the wax is oxidized petroleum wax, microcrystalline wax or a mixture thereof.

6. The anticorrosion wax composition containing plate zinc flake of claim 1, wherein the oil is at least one selected from the group consisting of mineral spirits, polybutene, butyl cellosolve and naphthene.

7. The anticorrosion wax composition containing plate zinc flake of claim 1, wherein the additives comprise a defoamer, surfactant or a mixture thereof.
